(19) United States
(12) Patent Application Publication
(10) Pub. No.: US 2025/0376878 A1
(43) Pub. Date: Dec. 11, 2025

(54) VEHICLE DOOR LATCH EQUIPMENT AND ASSOCIATED VEHICLE DOOR

(71) Applicant: Minebea AccessSolutions France, Alfortville (FR)

(72) Inventors: François DEBROUCKE, Alfortville (FR); Robin DUVAUCHELLE, Alfortville (FR); Jérémy PAUMELLE, Alfortville (FR)

(73) Assignee: Minebea AccessSolutions France, Alfortville (FR)

(21) Appl. No.: 19/233,445

(22) Filed: Jun. 10, 2025

(30) Foreign Application Priority Data
Jun. 11, 2024 (EP) 24315281

(51) Int. Cl. E05B 81/18; E05B 79/20; E05B 81/06; E05B 81/14; E05B 81/30; E05B 81/38

(52) U.S. Cl. CPC E05B 81/18; E05B 81/06; E05B 81/14; E05B 81/30; E05B 81/38; E05B 79/20

(57) ABSTRACT

A vehicle door latch equipment includes an engagement mechanism to engage with a striker, a rotatable opening lever to rotate between a rest position and an actuation position wherein the rotatable opening lever releases the engagement mechanism, and an electrical release mechanism including an electrical release motor with an output shaft and a worm arranged on the output shaft of the electrical release motor which is arranged to mesh with a gear wheel in order to displace the rotatable opening lever. The electrical release mechanism also includes a planetary gear arranged between the electrical release motor and the rotatable opening lever.

### TECHNICAL FIELD

The present invention relates to the field of vehicle door latches to ensure the closing of vehicle doors and in particular to latches comprising an electrical release mechanism.

### BACKGROUND OF THE INVENTION

The present invention refers to a vehicle door latch equipment comprising an electrical release mechanism also called E-release mechanism.

Such an electrical release mechanism is usually deployed in combination with a manual back up release mechanism so that both release mechanisms have to be packed in a reduced space.

Furthermore, the electrical release mechanism has to open the door in a whole range of conditions that will be faced during the lifetime of the vehicle.

In particular, the vehicle may cope with low temperatures that may harden the seal so that a force high enough is then necessary to open the door. Such a high force may also be needed in case of a crash of the vehicle.

It is therefore a goal of the present invention to provide a vehicle door latch equipment with an electrical release mechanism having a compact size and capable of applying a high force, for example higher than 600N, to compress the seal.

### SUMMARY OF THE INVENTION

The present invention refers to a vehicle door latch equipment comprising:
an engagement mechanism configured for engaging with a striker,
a rotatable opening lever configured to rotate between a rest position and an actuation position wherein the rotatable opening lever releases the engagement mechanism,
an electrical release mechanism comprising an electrical release motor with an output shaft and a worm arranged on the output shaft of the electrical release motor which is configured to mesh with a gear wheel in order to displace the rotatable opening lever,
   wherein the electrical release mechanism also comprises a planetary gear arranged between the electrical release motor and the rotatable opening lever.

The use of a planetary gear enables having a mechanical release mechanism with a high torque in a limited space.

According to another aspect of the present invention, the planetary gear comprises at least a sun gear which is coupled in rotation with the gear wheel that is configured to mesh with the worm arranged on the output shaft of the electrical release motor, a ring gear, planet gears configured to mesh on one side with the sun gear and on the other side with the ring gear and a planet carrier, the planet carrier being configured to displace the rotatable opening lever between its rest position and its actuation position.

According to another aspect of the present invention, the ring gear is configured to be fixed with respect to a housing of the vehicle door latch equipment.

According to another aspect of the present invention, the worm comprises a single lead thread, a double-lead threads or a triple-lead threads according to the desired gear ratio of the electrical release mechanism.

According to another aspect of the present invention, the gear ratio of the set comprising the gear wheel-worm mechanism and the planetary gear is comprised between 150 and 300.

According to another aspect of the present invention, the vehicle door latch equipment comprises a spring arranged between the rotatable opening lever and a part which is fixed with respect to a housing of the vehicle door latch equipment to bring the rotatable opening lever back in the rest position.

According to another aspect of the present invention, the vehicle door latch equipment also comprises a mechanical release mechanism comprising a rotatable mechanical lever configured to be linked mechanically to a handle to be rotated between a rest position and an opening position, the rotatable opening lever being displaced by the rotatable mechanical lever so that the rotatable opening lever is in the actuation position when the rotatable mechanical lever is rotated in the opening position.

According to another aspect of the present invention, the rotatable mechanical lever is linked to a return spring configured to bring the rotatable mechanical lever back in the rest position.

According to another aspect of the present invention, the vehicle door latch equipment also comprises a locking mechanism comprising an electrical locking motor with an output shaft, a worm arranged on the output shaft of the electrical locking motor, a locking gear wheel configured to mesh with the worm to be rotated between an unlock position and a lock position and a locking lever configured to be displaced by the locking gear wheel between a first position associated with the lock position of the locking gear wheel wherein the locking lever prevents the release of the engagement mechanism and a second position associated with the unlock position of the locking gear wheel wherein the engagement mechanism can be released.

The present invention also refers to a vehicle door comprising a vehicle door latch equipment as described previously and a handle configured to be mechanically linked to the rotatable mechanical lever of the vehicle door latch equipment.

According to another aspect of the present invention, the handle is an inner handle.

According to another aspect of the present invention, the rotatable mechanical lever is linked to the handle by a Bowden cable or by a rod.

### BRIEF DESCRIPTION OF THE DRAWINGS

FIG. 1 is a perspective view of a vehicle door latch equipment according to an embodiment of the present invention;

FIG. 2 is a first perspective view of inner parts of a vehicle door latch equipment according to an embodiment of the present invention;

FIG. 3 is a second perspective view of inner parts of a vehicle door latch equipment according to an embodiment of the present invention;

FIG. 4 is an exploded view of the planetary gear of the electrical release mechanism;

FIG. 5 is a kinematic diagram of the planetary gear of the electrical release mechanism.

### DETAILED DESCRIPTION OF THE INVENTION

The following achievements are examples. Although, the specification refers to one or several embodiments, it does not imply that each reference refers to the same embodiment or that the features apply only to a single embodiment. Simple features of different embodiments can also be combined to provide other embodiments.

The present invention refers to a vehicle door latch equipment 1 configured to ensure the closing of a vehicle door, in particular a side door or a trunk lid.

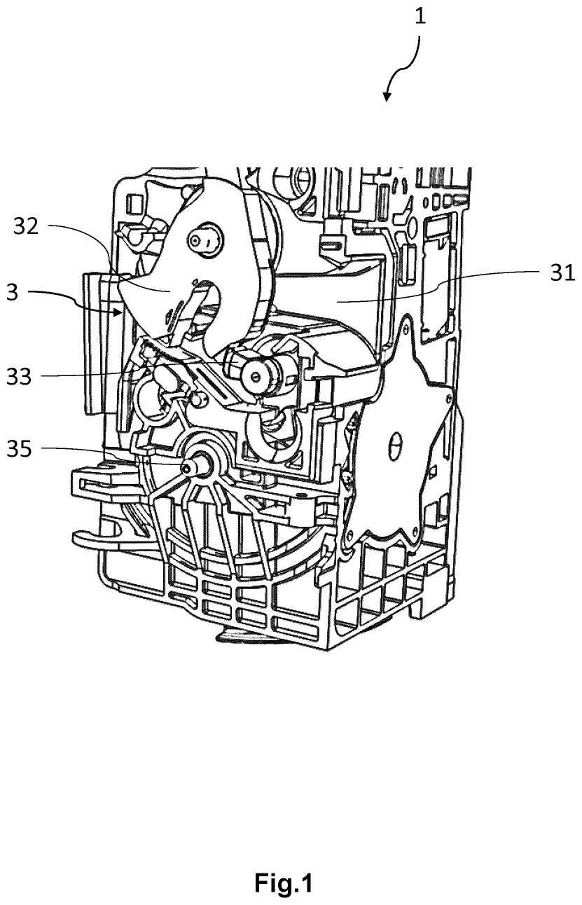

FIG. 1 represents an example of such vehicle door latch equipment 1. In the following of the description, the presented vehicle door latch equipment 1 comprises an electrical release mechanism 9 combined with a mechanical release mechanism 19 but the present invention may also be applied on a vehicle door latch comprising only an electrical release mechanism 9.

The vehicle door latch equipment 1 comprises an engagement mechanism 3 configured for engaging with a striker (not represented). The striker is arranged on the vehicle body next to the vehicle door and is configured to be introduced into a recess 31 of the vehicle door latch equipment 1 when the vehicle door is closed. The engagement mechanism 3 comprises a claw 32 arranged at least partially in the recess 31 and configured to move between a closed position (as represented in FIG. 1) wherein the striker is retained within the recess 31 by the claw 32 and an opened position wherein the striker may be disengaged from the vehicle door latch equipment 1. The engagement mechanism 3 also comprises a pawl 33 configured to rotate between a blocking position (represented in FIG. 1) wherein the pawl 33 blocks the rotation of the claw 32 so that the striker is retain by the claw 32 and a release position wherein the pawl 33 enables the rotation of the claw 32 and therefore the release of the striker to open the door.

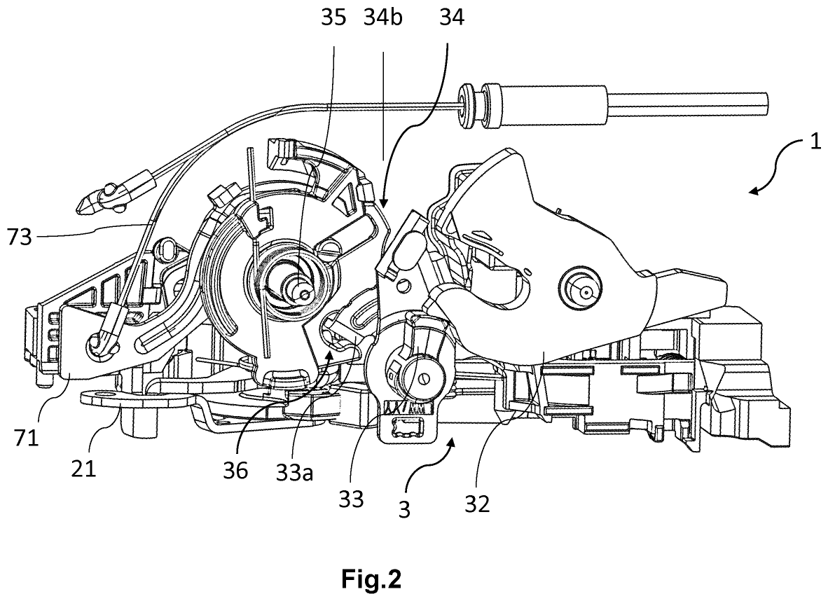

As represented in FIG. 2, the engagement mechanism 3 also comprises a driver 34 configured to rotate around a first shaft 35 and to engage with the pawl 33 to rotate the pawl 33 between its blocking position and its release position. The driver 34 may comprises a notch 36 configured to receive a lever 33a of the pawl 33.

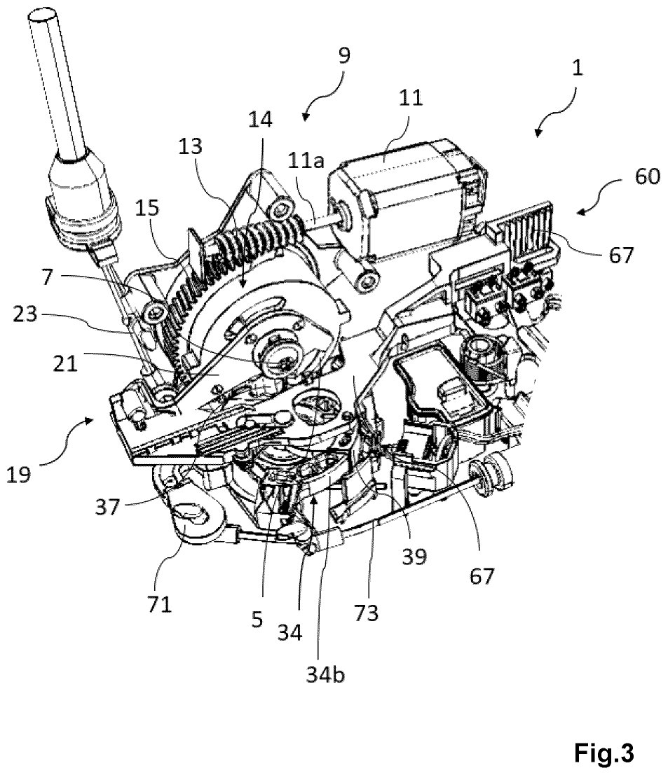

As represented in FIG. 3, the vehicle door latch equipment 1 also comprises an electric release mechanism 9. The electric release mechanism 9 comprises an electric release motor 11 with an output shaft 11a. According to an embodiment of the invention, the electric release motor 11 is a reversible motor (the output shaft 11a of the electric release motor 11 can be rotated in a clockwise or a counterclockwise direction). A worm 13 is arranged on the output shaft 11a of the electrical release motor 11 and is configured to mesh with a gear wheel 15.

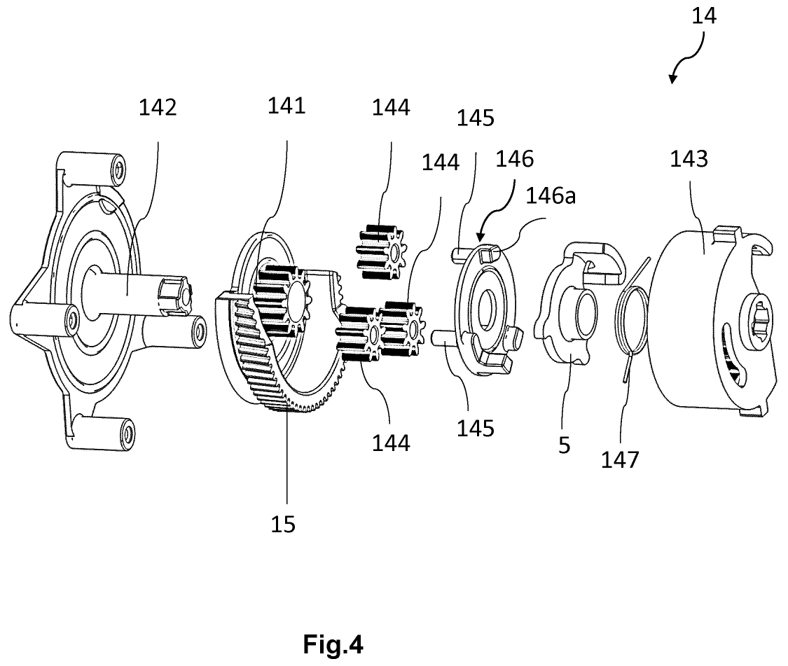

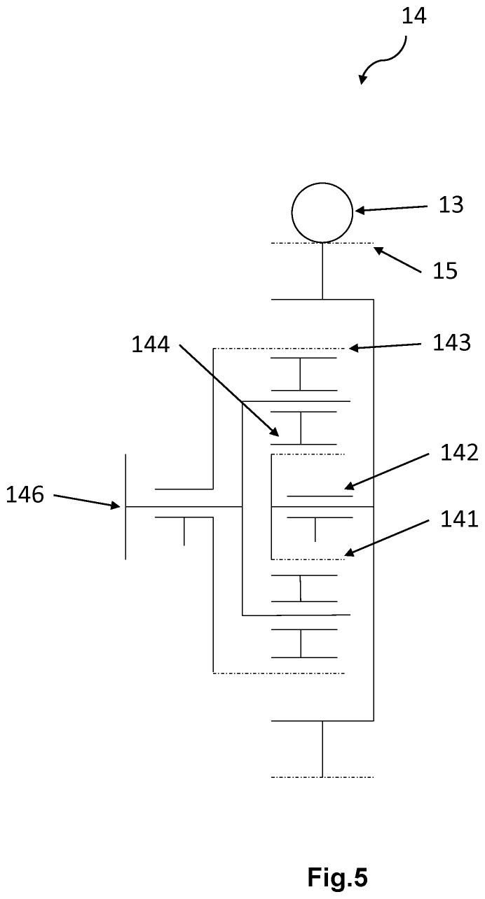

The electrical release mechanism 9 also comprises a planetary gear 14. FIG. 4 represents an embodiment of the planetary gear 14 according to the invention and FIG. 5 represents the kinematic diagram of the planetary gear 14.

The planetary gear 14 comprises at least a sun gear 141 which is coupled in rotation with the gear wheel 15. In the present case, the sun gear 141 and the gear wheel 15 are arranged on a common part. Furthermore, the gear wheel 15 may comprise teeth only on a portion of circle depending on the required angular amplitude. The planetary gear 14 also comprises a ring gear 143 and three planet gears 144 configured to mesh on one side with the sun gear 141 and on the other side with the ring gear 143. The planet gears 144 are arranged rotatably on three respective shafts 145 of a planet carrier 146.

The planetary gear 14 also comprises a rotatable opening lever 5 which is configured to be displaced by the planet carrier 146 from a rest position to an actuation position wherein the rotatable opening lever 5 pushes a protruding element 37 of the driver 34 to release the engagement mechanism 3 and to open the door.

The planetary gear 14 may also comprise a spring 147 having a first end configured to come in contact with the rotatable opening lever 5 and a second end configured to come in contact with a housing part of the vehicle door latch equipment (such as the ring gear 143) in order to constrain the rotatable opening lever 5 towards its rest position. Alternatively, the rotatable opening lever 5 may be located outside of the planetary gear 14.

Thus, the electrical release motor 11 is configured to rotate the gear wheel 15 and therefore the sun gear 141 which is the input of the planetary gear 14. As the ring gear 143 is part of the planetary gear 14 housing (with the cover 142 comprising the shaft of the planetary gear 14) and is therefore motionless (with respect to the vehicle door latch equipment 1 housing), the rotation of the sun gear 141 leads to the rotation of the planet gears 144 and therefore to the rotation of the planet carrier 146 which is the output of the planetary gear 14. The planet carrier 146 may comprise an axial protuberance 146a configured to engage with the rotatable opening lever 5 so that the rotation of the planet carrier 146 leads to the rotation of the rotatable opening lever 5 and therefore to the release of the engagement mechanism 3.

Alternatively or in combination, the rotatable opening lever 5 may comprise an axial protuberance.

The gear ratio of the set comprising the gear wheel 15-worm 13 mechanism and the planetary gear 14 may be comprised between 150 and 300. In particular, the worm 13 may comprise a double-lead threads or a triple-lead threads according to the desired gear ratio for the electrical release mechanism 9.

Thus, the combination of a gear wheel 15-worm 13 mechanism and a planetary gear 14 enables to obtain a compact mechanism with a large gear ratio so that a high torque can be apply on the pawl 33 to ensure the opening of the door even when the seal is hardened due to cold weather conditions with low temperatures.

A planetary having a different configuration may also be used without departing from the scope of the present invention. For example, the input part, output part and motionless parts may be different and the number of planet gears 144 may be different than three.

The vehicle door latch equipment 1 may also comprise a mechanical release mechanism 19. As represented in FIG. 3, the mechanical release mechanism 19 comprises a rotatable mechanical lever 21 configured to be linked mechanically to a handle, for example to an inner handle of the vehicle. The rotatable mechanical lever 21 may be linked to the handle by a Bowden cable 23 (visible in FIG. 3) or by a rod. The rotatable mechanical lever 21 is configured to be rotated between a rest position and an opening position. The rotation of the rotatable mechanical lever 21 towards its opening position leading to the rotation of the rotatable opening lever 5 towards its actuation position.

A return spring may be arranged between the rotatable mechanical lever 21 and a housing of the vehicle door latch equipment 1 to bring the rotatable mechanical lever 21 back in the rest position when a user releases the handle linked to the rotatable mechanical lever 21.

Thus, the rotation of the rotatable mechanical lever 21 from its rest position towards its opening position leads to the rotation of the rotatable opening lever 5 in its actuation position and therefore to the release of the engagement mechanism 3. The rotatable mechanical lever 21 may be arranged around the same shaft 7 as the planetary gear 14.

According to an embodiment of the present invention, the vehicle door latch equipment 1 comprises a locking mechanism 60 configured to lock the vehicle door to prevent a user to enter the vehicle from the outside. The locking mechanism 60 comprises an electrical locking motor (not represented) with an output shaft, a worm arranged on the output shaft of the electrical locking motor, a locking gear wheel configured to mesh with the worm to be rotated between an unlock position and a lock position and a locking lever 67 configured to be displaced by the locking gear wheel between a first position associated with the lock position of the locking gear wheel wherein the locking lever 67 prevents the release of the engagement mechanism 3 and a second position associated with the unlock position of the locking gear wheel 65 wherein the engagement mechanism 3 can be released.

The vehicle door latch equipment 1 may also comprise an additional mechanical lever 71 configured to be linked to a handle, for example an outer handle. The additional mechanical lever 71 may be linked to the outer handle by a Bowden cable 73 (as represented in FIG. 3) or by a rod.

The vehicle door latch equipment 1 may also comprise an override function to unlock the locking mechanism 60 when a mechanical opening is triggered from an inner handle (to prevent a user to be locked outside of the vehicle after a mechanical opening from an inner handle). The vehicle door latch equipment 1 may comprise an override lever arranged between the rotatable mechanical lever 21 and the locking lever 67. The override lever is configured to displace the locking lever 67 towards its second position when rotatable mechanical lever 21 is rotated towards its opening position. The displacement of the locking lever 67 towards its second position leads also the locking gear wheel to rotate towards its unlock position. A contactor may be arranged next to the locking lever to detect its displacement towards its second position in order to trigger the rotation of the electrical locking motor to bring the locking gear wheel back to its unlock position.

Moreover, in order to prevent the override function when the outer handle is pulled by a user, the engagement mechanism 3 may comprise a clutch paddle 39 arranged between the locking lever 67 and the driver 34. In this embodiment, the driver 34 is made of a first part 34a comprising the protruding element 37 and a second part 34b. The clutch paddle 39 is configured to be displaced by the locking lever 67 (when the locking lever 67 is displaced from its first to its second position) from a retracted position to an engaged position wherein the clutch paddle 39 is positioned between the first part 34a and the second part 34b of the driver 34. Furthermore, the additional mechanical lever 71 is configured to rotate the second part 34b of the driver 34 when a user pulls on the outer handle.

As a consequence, if the locking lever 67 is in the first position, the clutch paddle 39 is in its retracted position so that the displacement of the additional mechanical lever 71 via the outer handle leads to the rotation of the second part 34b of the driver 34 towards the first part 34a of the driver 34 but the first part 34a of the driver 34 is not rotated so that the pawl 33 remains in its blocking position. The door remains therefore closed. On the contrary, if the locking lever 67 is in the second position, the clutch paddle 39 is in its engaged position so that the displacement of the additional mechanical lever 71 via the outer handle leads to the rotation of the second part 34b which leads to the rotation of the first part 34a via the clutch paddle 39 which is engaged between the second part 34b and the first part 34b of the driver 34. The pawl 33 is then rotated in its released position and the door is opened.

The vehicle door latch equipment 1 may also comprise additional springs to constraint the different parts of the vehicle door latch equipment 1 towards a predetermined position.

Thus, the vehicle door latch equipment 1 presented in the different figures provides a compact equipment comprising an electrical release mechanism capable of opening the door in all weather conditions and which can also provide a mechanical release mechanism in a compact size with different options such as an override function to prevent a user from being locked outside his vehicle when the door is opened from an inner handle.

The present invention also refers to a vehicle door comprising a vehicle door latch equipment 1 as described previously and a handle configured to be linked mechanically to the rotatable mechanical lever 21, for example by a rod or a Bowden cable. The handle may be an inner handle. The vehicle door may also comprise an outer handle linked mechanically to the vehicle door latch equipment 1, for example by a rod or a Bowden cable to an additional mechanical lever 71.

1-12. (canceled)

13. Vehicle door latch equipment, comprising:
an engagement mechanism configured to engage with a striker;
a rotatable opening lever configured to rotate between a rest position and an actuation position wherein the rotatable opening lever releases the engagement mechanism;
an electrical release mechanism comprising an electrical release motor with an output shaft and a worm arranged on the output shaft of the electrical release motor which is configured to mesh with a gear wheel in order to displace the rotatable opening lever,
wherein the electrical release mechanism further comprises a planetary gear arranged between the electrical release motor and the rotatable opening lever.

14. The vehicle door latch equipment in accordance with claim 13, wherein the planetary gear comprises a sun gear which is coupled in rotation with the gear wheel that is configured to mesh with the worm arranged on the output shaft of the electrical release motor, a ring gear, planet gears configured to mesh on one side with the sun gear and on the other side with the ring gear, and a planet carrier, the planet carrier being configured to displace the rotatable opening lever between its rest position and its actuation position.

15. The vehicle door latch equipment in accordance with claim 14, wherein the ring gear is configured to be fixed with respect to a housing of the vehicle door latch equipment.

16. The vehicle door latch equipment in accordance with claim 13, wherein the worm comprises a single lead thread, a double-lead threads, or a triple-lead threads according to a predetermined gear ratio of the electrical release mechanism.

17. The vehicle door latch equipment in accordance with claim 16, wherein the gear ratio of a set comprising a mechanism including the gear wheel the worm and the planetary gear is comprised between 150 and 300.

18. The vehicle door latch equipment in accordance with claim 13, further comprising a spring arranged between the rotatable opening lever and a part which is fixed with respect to a housing of the vehicle door latch equipment to bring the rotatable opening lever back in the rest position.

19. The vehicle door latch equipment in accordance with claim 13, further comprising a mechanical release mechanism comprising a rotatable mechanical lever configured to be linked mechanically to a handle to be rotated between a rest position and an opening position, the rotatable opening lever being displaced by the rotatable mechanical lever so that the rotatable opening lever is in the actuation position when the rotatable mechanical lever is rotated in the opening position.

20. The vehicle door latch equipment in accordance with claim 19, wherein the rotatable mechanical lever is linked to a return spring configured to bring the rotatable mechanical lever back in the rest position.

21. The vehicle door latch equipment in accordance with claim 13, further comprising a locking mechanism comprising an electrical locking motor with an output shaft, a worm arranged on the output shaft of the electrical locking motor, a locking gear wheel configured to mesh with the worm to be rotated between an unlock position and a lock position and a locking lever configured to be displaced by the locking gear wheel between a first position associated with the lock position of the locking gear wheel wherein the locking lever prevents the release of the engagement mechanism and a second position associated with the unlock position of the locking gear wheel wherein the engagement mechanism can be released.

22. A vehicle door comprising:
the vehicle door latch equipment in accordance with claim 19; and
the handle configured to be mechanically linked to a rotatable mechanical lever.

23. The vehicle door in accordance with claim 22, wherein the handle is an inner handle.

24. The vehicle door in accordance with claim 22, wherein the rotatable mechanical lever is linked to the handle by a Bowden cable or by a rod.
